(19) United States
(12) Patent Application Publication
(10) Pub. No.: US 2004/0264641 A1
(43) Pub. Date: Dec. 30, 2004

(54) Apparatus for measuring energy resolving power of X-ray monochromator and solid sample using in the same

(75) Inventor: Young-su Chung, Gyeonggi-do (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Gyeonggi-do (KR)

(21) Appl. No.: 10/876,585

(22) Filed: Jun. 28, 2004

(30) Foreign Application Priority Data
Jun. 27, 2003 (KR) 10-2003-0042773

(51) Int. Cl. G21K 1/06; H01J 35/08

(52) U.S. Cl. 378/84

(57) ABSTRACT

Provided is an apparatus for measuring an energy resolving power of X-ray monochromator and a solid sample used for the same. The apparatus comprises an X-ray generator, a monochromator to select a X-ray discharged from the X-ray generator, a main chamber to which the selected X-ray by the monochromator is injected, a solid sample disposed in the main chamber where the selected X-ray is injected for measuring the energy resolving power of the monochromator, and equipments to analyze and handle data obtained from the solid sample while the X-ray is injected to the solid sample. The solid sample is composed of a plurality of atoms, wherein a molecule having at least two atoms exists between the plurality of atoms.

### BACKGROUND OF THE INVENTION

1. Field of the Invention

The present invention relates to an apparatus for measuring an energy resolving power and a sample used therein, and more particularly, to an apparatus for measuring an energy resolving power of X-ray monochromator and solid samples used therein.

2. Description of the Related Art

Along with the developments in nano technology, there is a growth in the importance of using x-ray for structural analysis, particularly, for structural analysis of solids and nano molecules.

An X-ray absorption spectroscopy (XAS) or an X-ray photoemission spectroscopy (XPS) are representative methods for analyzing material structure using X-ray. The XAS or XPS provides information on energy level, particularly, energy level in association with chemical bonding of the material to be analyzed.

The XAS or XPS uses mainly a soft X-ray. In order to make correct identification of molecular structure of a material using XAS or XPS, an energy resolving power of the X-ray to be applied to the subject material. Afterwards, an accurate energy calibration based on the measurement result is performed.

In the XAS or XPS, X-ray generated from the X-ray source is injected to a monochromator. In the monochromator, X-ray having a suitable energy level for material analysis is selected. The selected X-ray is injected to a chamber in which a subject material is placed.

Accordingly, the measurement of energy resolving power and energy calibration in the XAS or XPS portray the energy resolving power and the energy calibration of the monochromator.

An initial setting value of the energy resolving power and the energy calibration of the XAS or XPS may vary according to the environmental change or a change of operating condition of the equipments used. Therefore, it is important to perform the measurement of the energy resolving power and the energy calibration of the monochromator periodically to maintain uniform performance of the material analysis.

FIG. 1 shows a conventional energy resolving power measurement apparatus (hereinafter, conventional apparatus) of X-ray monochromator.

Referring to FIG. 1, the conventional apparatus comprises an X-ray generator 10, a monochromator 12 which discharges X-ray 16 having a suitable energy level for material analysis after selecting an X-ray from the X-ray 14 inputted from the X-ray generator 10, a gas cell 22 used as a sample for measuring the energy resolving power of X-ray discharged from the monochromator 12, a main chamber 24 for placing a sample material 26 to be analyzed, a gas source 46 for supplying nitrogen gas N₂ to the gas cell 22, and equipments 32, 34, 36, 38, and 40 for analyzing and executing data obtained from the gas cell 22 and the main chamber 24. A first gate valve 18 is disposed on a side of the gas cell 22 facing the monochromator 12. A thin aluminum film 20 having a thickness of 100˜150 nm is disposed in the first gate valve 18.

Pressure in the X-ray tube BL is 10⁻⁹˜10⁻¹⁰ Torr, while that of the gas cell 22 is about 100 mTorr. Due to the pressure difference, a diaphragm is required for passing the X-ray between the X-ray tube BL and the gas cell 22. The thin aluminum film 20 is for this purpose.

The gas cell 22 and the main chamber 24 are connected interposing a valve 30 between them. A sample holder 28 for holding sample material 26 is disposed in the main chamber 24. The sample holder 28 is connected to the first current amplifier 32 which is one of the equipments, through a sidewall of the main chamber 24. The first current amplifier 32 amplifies a current that is generated by the sample material 26 and inputted through the sample holder 28. The amplified sample current by the first current amplifier 32 is transformed to frequencies while passing through a voltage-frequency converter 34, and the converted frequencies are read by the counter 36, and then analyzed and executed at the data analyzer and data executing equipment 38.

When the X-ray 16 is injected to the gas cell 22 filled with nitrogen gases through the thin aluminum film 20, nitrogen gas ions are produced in the gas cell 22, thereby generating a current. The current generated in the gas cell 22 contains an information about the X-ray 16, that is, an information of energy resolving power of X-ray monochromator 12. The current generated in the gas cell 22 is amplified at a second amplifier 40 connected to the gas cell 22, and transformed to frequencies while passing through a voltage-frequency converter 34, and the converted frequencies are read by the counter 36, and then analyzed and executed at the data analyzer and data executing equipment 38. Through this analysis, the energy resolving power of the monochromator 12 can be measured and the energy calibration is achieved.

Nitrogen gas supply pipeline 44 is disposed between the gas cell 22 and a gas source 46, and a valve 42 is mounted between the gas cell 22 and the Nitrogen gas supply pipeline 44. Also, a valve 48 is disposed between the Nitrogen gas supply pipeline 44 and the gas source 46.

While, when the X-ray 16 is injected to the gas cell 22, the energy level of electrons of nitrogen gas filled in the gas cell 22 is transited from the 1 s level to π* level by absorbing energy of 400.80 eV. As the result, an absorption peak corresponding to 400.80 eV is observed.

FIG. 2 shows absorption peaks of the energy. In FIG. 2, reference character G1 (first graph) represents photon energy, i.e., an ionization degree of nitrogen gas in the cell 22 according to energy of the X-ray 16 injected to the gas cell 22. Reference character P1 represents an absorption peak corresponding to 400.80 eV.

The π* energy level of nitrogen gas has several sub-energy levels. An electron of 1 s energy level can be transited to a sub energy level in the process of transition to the π* level. Therefore, a second through a fifth absorption peaks P2, P3, P4, and P5 in addition to the P1 are observed.

Referring to the first through fifth absorption peaks P1, P2, P3, P4, and P5, it is seen that the first peak P1 appears when the transition occurs at the lowest level of π* energy level.

In FIG. 2, reference characters GP1 through GP5 represent first through fifth voigt distribution curves corresponding to first through fifth absorption peaks, respectively. The voigt distribution curve is a convolution of Gaussian distribution of a monochromator and observed transition lines of Lorentzian distribution. A Gaussian width can be obtained by deconvolution of the natural Lorentzian width (132 meV) in the voigt distribution curve. The energy resolving power of the monochromator is obtained by dividing the energy by the Gaussian width.

Also, the energy calibration is made based on the first absorption peak P1 observed.

The conventional apparatus has advantages in that the gas cell 22 can measure the energy resolving power level as high as approximately 10,000 eV, and energy resolving power in different regions by varying the gas.

However, the conventional apparatus has the following disadvantages.

First, the gas cell 22 and the X-ray tube are separated by a thin aluminum film 20 diaphragm having a thickness of 100˜150 nm due to the pressure difference between the two chambers. Therefore, there is a high possibility of tearing or breaking of the thin aluminum film and a high risk of vacuum accident.

Second, at least 50 cm of distance for disposing equipments or parts to include the gas cell 22 and the first gate valve 18 is required between the X-ray tube BL and the main chamber 24 along the injection direction of X-ray.

Third, in order to attach or detach the gas cell 22 between the X-ray tube BL and the main chamber 24, vacuum work has to be done because of the pressure difference between the gas cell 22 and the X-ray tube BL. This operation is time consuming and complicated for attaching and detaching the gas cell 22.

Fourth, there is a high risk of exposure of the thin aluminum film 20 to air while attaching and detaching the gas cell 22, thereby reducing the lifetime of the thin aluminum film 20.

Fifth, continuous maintenance of the gas supply pipeline 44 is necessary to sustain the required purity and pressure of the gas cell 22. Therefore, costs for parts associate with maintaining the thin aluminum film 20 and gas supply pipeline 44 can be burdensome.

### SUMMARY OF THE INVENTION

The present invention provides an apparatus of simple structure for measuring an energy resolving power of X-ray monochromator energy level of 100˜1,000 eV with simplicity.

The present invention also provides a solid sample for measuring the energy resolving power in the apparatus for measuring an energy resolving power of X-ray monochromator.

According to an aspect of the present invention, the apparatus for measuring an energy resolving power of X-ray monochromator comprises an X-ray generator, a monochromator to select X-ray discharged from the X-ray generator, a main chamber to which the selected X-ray is injected, a solid sample disposed in the main chamber where the selected X-ray is injected for measuring the energy resolving power of the monochromator, and equipments to analyze and handle data obtained while the X-ray is injected to the solid sample.

The solid sample is disposed on one side and a holder connected to the accessory is disposed on the other side in the main chamber. The solid sample can be disposed on the bottom of the main chamber.

The equipments are a current amplifier, a voltage-frequency converter, a counter, and a data analysis and executing unit, sequentially connected to the solid sample.

The solid sample is a nitride in which nitrogen molecule N₂ is trapped, preferably it is silicon oxynitride (SiON), but it can be a nitride dielectric material having a low dielectric constant and a pore structure, a nitride having carbon nanotube structure, or a nitride including porous silicon.

According to another aspect of the present invention, a solid sample composed of a plurality of atoms, wherein a molecule having at least two atoms exists between the plurality of atoms.

In the solid sample, the plurality of atoms exist in the form of ring shape and the molecule is trapped in the ring. The plurality of atoms are silicon Si, oxygen O, and nitrogen N and the molecule is one of N₂ and N₂⁺.

One of the plurality of atoms is nitrogen N, and the rest of the plurality of atoms may be atoms constituting a dielectric material having a low dielectric constant, a material having a nanotube structure, or a porous material. In this case, the molecule is nitrogen molecule N₂.

The use of the present invention enables the apparatus for measuring an energy resolving power of X-ray monochromator to make simple configuration with reduced volume. Accordingly, costs for components can be reduced. Easiness of placing and retrieving of the solid sample provides a high time efficiency of the operation.

### BRIEF DESCRIPTION OF THE DRAWINGS

FIG. 1 shows a conventional apparatus for measuring an energy resolving power of X-ray monochromator;

FIG. 2 is a graph showing absorption peaks measured using a gas cell of an apparatus for measuring an energy resolving power of X-ray monochromator depicted in FIG. 1;

FIG. 3 shows an apparatus for measuring an energy resolving power of X-ray monochromator according to an embodiment of the present invention; and

FIGS. 4 and 5 are graphs showing absorption peaks measured using an apparatus for measuring an energy resolving power of X-ray monochromator depicted in FIG. 3, in which FIG. 5 is a measurement result of a solid sample after 6 months the measurement in FIG. 4 was made.

### DETAILED DESCRIPTION OF THE INVENTION

This application claims the priority of Korean Patent Application No. 2003-42773, filed on Jun. 27, 2003, in the Korean Intellectual Property Office, the disclosure of which is incorporated herein in its entirety by reference.

Hereinafter, an apparatus for measuring an energy resolving power of X-ray monochromator (hereinafter, present apparatus) and a solid sample used for measuring an energy resolving power will be described in detail with reference to the accompanying drawings. The shapes of elements in the drawings are exaggerated for easier presentation. To facilitate understanding, identical reference numerals in the conventional apparatus have been used to designate identical elements.

A feature of the present apparatus is that the overall configuration of the present apparatus is simplified by employing a solid sample capable of simply checking a beam line performance which uses x-ray having energy level of 100˜1,000 eV (maximum 5,000 eV).

More specifically, referring to FIG. 3, the present apparatus comprises an X-ray generator 10, a monochromator 12 that selects an X-ray 16 suitable for material analysis from the discharged X-ray 14 from the X-ray generator 10, a solid sample 54, energy resolving power of which will be measured against a selected X-ray generated by the monochromator 12, a main chamber 50 that contains a solid sample, a second gate valve 52 that separates a beam line and the main chamber 50, and equipments 58, 60, 62, and 64 for executing and analyzing data obtained from the solid sample by injecting the X-ray to the solid sample 54. The equipments 58, 60, 62, and 64 are disposed outside of the main chamber 50. The pressure in the chamber is maintained steadily, such as at 10⁻⁹˜10⁻¹⁰ Torr. The solid sample 54 is placed in a holder 56 in the main chamber 50. The holder 56 is connected to a current amplifier 58 for amplifying a current generated from the solid sample 54. A volt-frequency converter 60, a counter 62 and a data analysis and executing unit 64 are sequentially connected to the current amplifier 58. The volt-frequency converter 60 converts the current outputted from the current amplifier 58 to frequencies. The counter 62 counts the frequency converted. The data analysis and executing unit 64, in which a computer having a program for data analysis and executing is included, analyzes and executes data received from the solid sample 54 based on the counting on the counter 62.

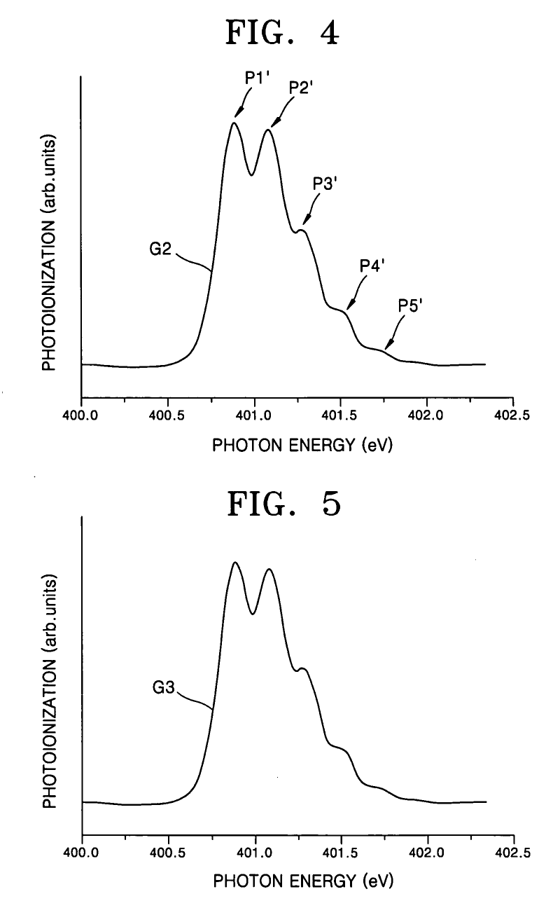

FIGS. 4 and 5 show the absorption peaks of the solid sample 54 of the selected X-ray 16 generated by the monochromator 12 as the results obtained from the data analysis and executing unit 64. The energy resolving power and its correctness of the X-ray 16 can be measured by analyzing the absorption peaks.

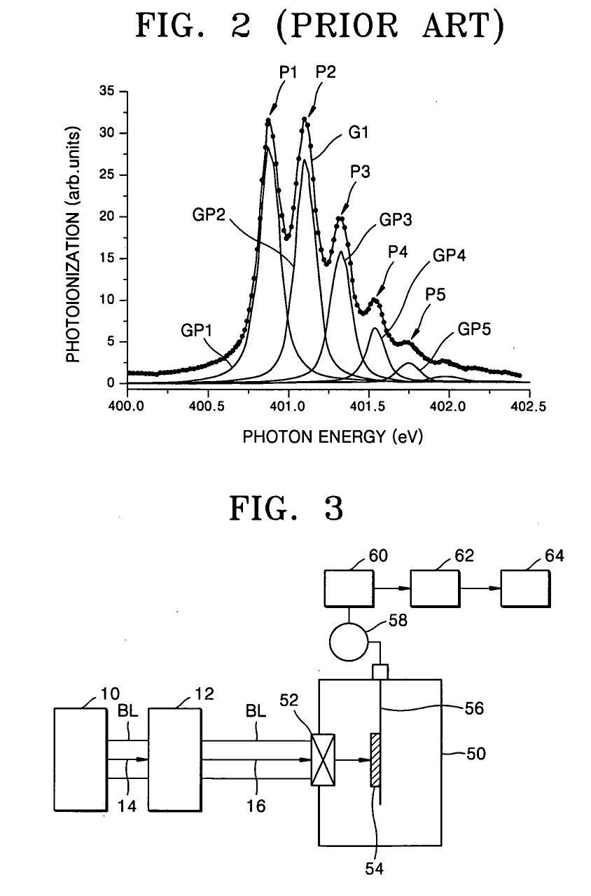

When comparing the second graph G2 in FIG. 4 and the first graph G1 in FIG. 2, it is seen that the shape of the second graph G2 is similar to that of the first graph G1. This is because the first graph was obtained by injecting an X-ray to the solid sample 54 that contains nitrogen molecule (will be described), and the second graph was obtained by injecting an X-ray 16 to the nitrogen molecule contained in the solid sample 54.

Reference characters P1′, P2′, P3′, P4′, and P5′ in FIG. 4 represent five absorption peaks appeared in the second graph G2. The five absorption peaks P1′ through P5′ correspond to the first through fifth absorption peaks P1 through P5 in the first graph G1. The first absorption peak P1′ can be used to calibrate the energy level to 400.80 eV as in the conventional case. Also, since the absorption peaks can be separated, the energy resolving power of the monochromator 12 can be measured by separating the absorption peak into a Gaussian distribution curve and a Lorentzian distribution curve.

That is, five voigt distribution curves (not shown) in respect to the individual five absorption peaks P1 through P5′ appeared in the second graph G2 can be obtained, and the five voigt distribution curves correspond to the first through the fifth voigt distribution curves GP1 through GP5 in FIG. 2. An energy resolving power and its accuracy of the monochromator 12 can be measured by obtaining widths of the five voigt distribution curves.

While, the third graph G3 in FIG. 5 is a measurement result of a solid sample 6 month after obtaining the result of the second graph G2 in FIG. 4. After obtaining the second graph G2 using the present apparatus depicted in FIG. 3, the solid sample 54 was removed from the present apparatus, and 6 month later, the sample was reloaded to the present apparatus to obtain the third graph G3. When compared the second and the third G2 and G3 graph, it is seen that the shape of the two graphs are equivalent.

The solid sample 54 was kept in an ordinary state, that is, it was not isolated from the air or under a specific condition but opened to ordinary atmosphere.

In spite of keeping the solid sample 54 used for measuring an energy resolving power in the present apparatus in an ordinary condition for 6 months, the obtained results from the solid sample 54 six month before and after are equivalent. This means, in fact, that the lifetime of the solid sample is semi permanent and appropriate to use for measuring an energy calibration purpose.

Now, the solid sample 54 will be described.

Preferably, the solid sample 54 is composed of silicon oxy nitride (SiON) including different sizes of linked ring of silicon Si-oxygen O-nitrogen Ni bond in which N₂ or N₂⁺ exist in the ring.

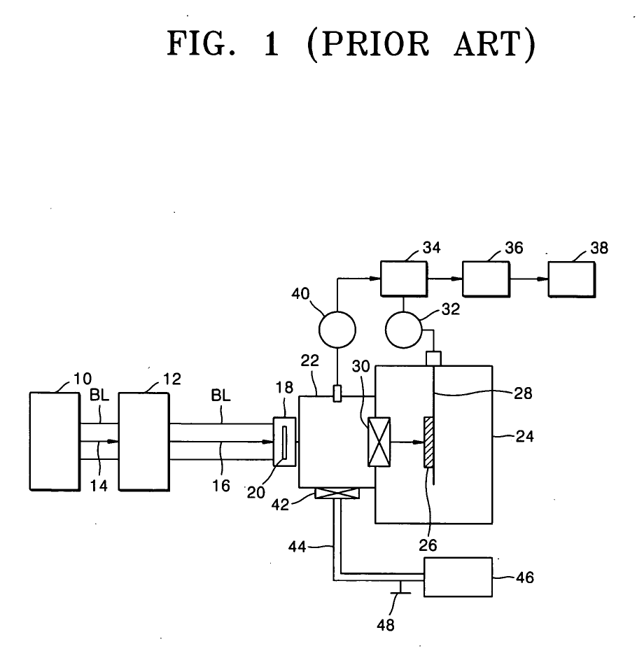

Since nitrogen exists in the ring in a molecule state, the shape of the second graph G2 which is a result obtained by injecting X-ray to the solid sample 54 and the shape of the first graph G1 in FIG. 2 which is a result obtained from the gas cell 22 in FIG. 1 filled by nitrogen gas of the conventional apparatus have to be equivalent.

The oxynitride (SiON) used for the solid sample is formed as the following process.

First, a silicon oxide film having a predetermined thickness of 15˜40 Å is formed on a substrate. An RF power of 400 W is applied to the silicon oxide film under a plasma atmosphere of a predetermined gas containing nitrogen such as a gas mixture of nitrogen and helium in a same ratio. Then, an amorphous silicon oxynitride is formed as the result of nitration of the silicon oxide film. In the nitration process utilizing plasma, nitrogen is trapped in the final product, i.e., silicon oxynitride as molecule state. This is possible since nitrogen molecule having a triple bond is very stable.

The solid sample 54 is preferably formed of silicon oxynitride, but it can be other material that can trap nitrogen in the molecule state, such as a dielectric material having a low dielectric constant (low-k) and nitrified pore structure, a nitride having carbon nanotube, or nitrified porous material (for example, nitrified porous silicon).

As mentioned above, the present apparatus is operated without the need for controlling pressure in the chamber but uses a solid sample in which nitrogen molecules are trapped. Therefore, the present apparatus does not require equipments constituted to the conventional apparatus such as the gas cell for filling nitrogen, the gas source for supplying nitrogen to the gas cell, gas supplying pipeline for connecting the gas cell and the gas source, the thin aluminum film for separating the gas cell and the X-ray tube due to the pressure difference, and valve for connecting the gas supplying pipeline to the gas cell. The configuration of the present apparatus is much simpler than that of the conventional one. The solid sample can be simply placed on the holder for material to be analyzed, and after measurement, also it can be simply separated from the holder. Keeping the solid sample does not require any specific care. Accordingly, the present apparatus provides a much higher time efficiency of operation in association with placing and retrieving the solid sample for measuring an energy resolving power including sample management after measurement. The present apparatus also provides space efficiency because the present apparatus does not require a distance as much as 50 cm along the X-ray direction between the X-ray tube and the main chamber due to the simple configuration of the present apparatus and the solid sample is so small that can put on a finger tip. The present apparatus can simply check the performance of beam line using X-ray having energy level of 100˜1,000 eV (maximum, 5,000 eV).

While this invention has been particularly shown and described with reference to embodiments thereof, it should not be construed as being limited to the embodiments set forth herein but as an exemplary. This invention may, however, be embodied in many different forms by those skilled in this art. For example, the solid sample can be replaced by a solid sample that contains a gas showing a clear absorption peak like nitrogen molecule, and accordingly an accessory equipment can further be included or can remove one of the accessories shown in FIG. 3. Also, the solid sample can be placed on the bottom of the main chamber, and can check the state of the solid sample in direct connection with the accessory equipment through the bottom of the main chamber. Therefore, the scope of the present invention shall be defined by the sprit of technical thought with reference to the appended claims, not by the embodiments set forth herein.

What is claimed is:

1. An apparatus for measuring an energy resolving power of X-ray monochromator comprising:
an X-ray generator;
a monochromator to select a X-ray discharged from the X-ray generator;
a main chamber to which a X-ray selected by the monochromator is injected;
a solid sample disposed in the main chamber where the selected X-ray is injected for measuring the energy resolving power of the monochromator; and
equipments to analyze and handle data obtained from the solid sample while the selected X-ray is injected to the solid sample.

2. The apparatus of claim 1, wherein the solid sample is disposed on one side and a holder connected to the equipments is disposed on the other side in the main chamber.

3. The apparatus of claim 1, wherein the solid sample is disposed on the bottom of the main chamber.

4. The apparatus of claim 1, wherein the equipments are a current amplifier, a voltage-frequency converter, a counter, and a data analysis and executing unit, sequentially connected to the solid sample.

5. The apparatus of claim 2, wherein the equipments are a current amplifier, a voltage-frequency converter, a counter, and a data analysis and executing unit, sequentially connected to the solid sample.

6. The apparatus of claim 1, wherein the solid sample is a nitride or oxynitride in which nitrogen molecule N₂ is trapped.

7. The apparatus of claim 6, wherein the nitride is one of silicon oxynitride (SiON), a nitrided dielectric material having a low dielectric constant and pore structure, a nitride having carbon nanotube structure, and a nitride including porous silicon.

8. A solid sample composed of a plurality of atoms, wherein a molecule having at least two atoms exists between a plurality of atoms constituting the solid sample.

9. The solid sample of claim 8, wherein the plurality of atoms exist in the form of ring shape and the molecule is trapped in the ring.

10. The solid sample of claim 8, wherein the plurality of atoms are silicon Si, oxygen O, and nitrogen N.

11. The solid sample of claim 9, wherein the plurality of atoms are silicon Si, oxygen O, and nitrogen N.

12. The solid sample of claim 8, wherein the molecule is one of N₂ and N₂⁺.

13. The solid sample of claim 9, wherein the molecule is one of N₂ and N₂⁺.

14. The solid sample of claim 8, wherein one of the plurality of atoms is nitrogen N.

15. The solid sample of claim 14, wherein the rest of the plurality of atoms are atoms constituting one of a dielectric material having a low dielectric constant, a material having a nanotube structure, and a porous material.

16. The solid sample of claim 14, wherein the molecule is nitrogen molecule N₂.

17. The solid sample of claim 15, wherein the molecule is nitrogen molecule N₂.
